(19) United States
(12) Patent Application Publication
(10) Pub. No.: US 2007/0204517 A1
(43) Pub. Date: Sep. 6, 2007

(54) Glider retainer block for a window regulator assembly

(75) Inventors: Eric Steven Willetts, Dearborn, MI (US); Gregory David Collins, Tecumseh (CA)

Correspondence Address: CARLSON, GASKEY & OLDS, P.C., 400 WEST MAPLE ROAD, SUITE 350, BIRMINGHAM, MI, 48009, US

(73) Assignee: ArvinMeritor Technology, LLC

(21) Appl. No.: 11/366,182

(22) Filed: Mar. 2, 2006

(51) Int. Cl. E05F 15/16

(52) U.S. Cl. 49/351; 49/349

(57) ABSTRACT

A window regulator assembly is easily coupled to a window with the use of a glider retainer block. The glider retainer block is selectively attached to a window lift channel to hold a glider at a desired position within the window lift channel. The glider is coupled to a regulator arm of the window regulator assembly. The glider retainer block is then attached to the window lift channel to hold the glider in the desired position. The window is then clamped to the window lift channel, and the glider retainer block is subsequently detached to allow relative movement between the window lift channel and glider.

### TECHNICAL FIELD

The subject invention relates to a glider retainer block that is selectively attached to a window lift channel to hold a glider associated with a window regulator assembly in a desired shipping and installation position.

### BACKGROUND OF THE INVENTION

Window regulators are used to control movement of a window between open and closed positions. The window, which is typically formed from glass, is clamped to a window lift channel with clamps. Typically, one window lift channel is coupled to each side of the window.

A glider is received within each window lift channel during assembly. First, the glider is coupled to the window regulator. Then the glider, with the window regulator attached, is inserted into the window lift channel. Finally, the window is attached to the window lift channel with the clamps.

One problem with this traditional assembly method is that, because the glider can move relative to the window lift channel, it is difficult to consistently position the window regulator in a precise and repeatable location for installing the window. This also means that the clamps do not consistently grip the same installation area on the window. Thus, one window regulator may have the clamps engaging the window at a first location and one window regulator may have the clamps engaging the window at a second location slightly different than the first location. This can adversely affect the efficiency of the window regulator, and the position of the window for proper sealing.

Thus, there is a need for a window regulator that can be consistently held at a desired installation position on a window lift channel.

### SUMMARY OF THE INVENTION

A glider retainer block is used to hold a window regulator in a desired installation position relative to a window lift channel. The glider retainer block holds a glider that is received within the window lift channel. The glider retainer block is selectively attached to the window lift channel. The glider is coupled to a window regulator component, such as a regulator arm. The glider is installed in the window lift channel, and then the glider retainer block is attached to the window lift channel to hold the glider in the desired installation position for shipping. During installation into a vehicle, a window is clamped to the window lift channel, and the glider retainer block is subsequently detached to allow relative movement between the window lift channel and glider.

The glider allows full motion of the window regulator before and after installation of the window. Thus, the glider retainer block is selectively attached to hold the glider in a desired position for window installation such that the window can be coupled to the window lift channel at a consistent and repeatable location.

In one example, the glider retainer block includes a body portion with a pair of upwardly extending arms that are inserted through openings in the window lift channel. Each upwardly extending arm includes a gripping end member that grips the window lift channel to hold the glider and glider retainer block in a fixed location on the window lift channel. In another example, the glider retainer block includes an angled surface that allows the glider retainer block to tip or tilt the window lift channel into a full open position to obtain full window insertion.

The glider retainer block of the present invention keeps the window regulator in a proper and consistent installation position, which accordingly allows the window lift channel to be consistently clamped to the same location on each window. These and other features of the present invention can be best understood from the following specification and drawings, the following of which is a brief description.

### BRIEF DESCRIPTION OF THE DRAWINGS

FIG. 1 is a perspective view of a window and window lift channel assembly incorporating the subject invention.

FIG. 2 is a perspective assembled view of a glider retainer block incorporating the subject invention.

FIG. 3 is a perspective exploded view of the glider retainer block of FIG. 2.

FIG. 4 is a side view of the glider retainer block of FIG. 2 with a glider.

FIG. 5 is another example of a glider retainer block incorporating the subject invention, but which does not show the glider.

FIG. 6 is an end view of the glider retainer block of FIG. 5 attached to a window lift channel without the glider but showing an angled surface that abuts a regulator arm.

FIG. 7 is a perspective view of the window lift channel.

FIG. 8 is a schematic view of an attachment interface between the glider and a regulator arm.

### DETAILED DESCRIPTION OF THE PREFERRED EMBODIMENT

FIG. 1 shows a window 12 that moves between open and closed positions relative to a vehicle structure, such as a vehicle door component for example. The window 12 is typically formed as a glass panel. A window lift channel 16 is positioned near a bottom of the window 12. Clamps 18 (only one is shown in FIG. 1) are used to attach each end of the window lift channel 16 to the window 12.

A glider retainer block 20 is used to hold a window regulator component in a proper position on the window lift channel 16 during shipping and during installation of the window 12 into the clamps 18. The window regulator component comprises a regulator arm 14 that is part of a window regulator assembly, which moves the window 12 between open and closed positions as known. Any type of window regulator assembly could be used with the subject glider retainer block 20. The glider retainer block 20 holds a glider 22 that is received within the window lift channel 16. The glider 22 is coupled to the regulator arm 14, which moves the glider 22 back and forth along the window lift channel 16.

The glider retainer block 20 is selectively attached to the window lift channel 16 to hold the glider 22 and regulator arm 14 in a desired position. The glider retainer block 20 remains attached to the window lift channel 16 during shipping and during installation of the window 12 to prevent the glider 22 from moving relative to the window lift channel 16. This allows the window regulator assembly to be maintained in a consistent, proper installation position and allows the clamps 18 to consistently clamp the same area on the window 12. When the glider retainer block 20 is detached, the glider 22 provides full motion of the window regulator assembly.

The glider retainer block 20 is shown greater detail in FIGS. 2-3. The glider 22 is received within the window lift channel 16, which includes a vertical side portion 32 and two guide grooves 34 that face each other from opposing edges of the vertical side portion 32. The glider 22 is in direct contact with both guide grooves 34.

A fastener 58 secures the glider 22 to the regulator arm 14 (see FIGS. 1 and 8). As shown in FIG. 8, the glider 22 is preferably attached to the regulator arm 14 by riveting. The fastener 58 comprises a rivet having a head 74 that is deformed from an initial position before riveting indicated by dashed lines, to a secured position after riveting, indicated by solid lines. The fastener 58 includes a pivotal connection portion 76 that is secured to the glider 22. This pivotal connection portion 76 is similar to a ball joint and allows the window lift channel 16 to tilt relative to the regulator arm 14.

The glider retainer block 20 includes a body portion 40 and first 42 and second 44 connector arms that extend outwardly from the body portion 40. Each distal end of the first 42 and second 44 connector arms includes a gripping member 46 that is inserted through a corresponding opening 48 in the window lift channel 16. Each gripping member 46 includes a notched portion 50 that allows the gripping member 46 to grip and hold onto an outer surface of the window lift channel 16. The first 42 and second 44 connector arms are resilient such that the gripping members 46 move away from each other during insertion into the openings 48 and then move inwardly toward each other after insertion such that the gripping members 46 can directly engage an upper surface of the window lift channel 16.

The first 42 and second 44 connector arms are positioned on opposite sides of the glider 22 such that when the glider retainer block 20 is attached to the window lift channel 16, the glider 22 is held fixed relative to the window lift channel 16 between the first 42 and second 44 connector arms. The glider retainer block 20 also includes first 52 and second 54 pairs of side arms. The first pair of side arms 52 abuts against the vertical side portion 32 of the window lift channel 16 and the second pair of side arms 54 abuts against inwardly extending flanges 56 of the guide grooves 34.

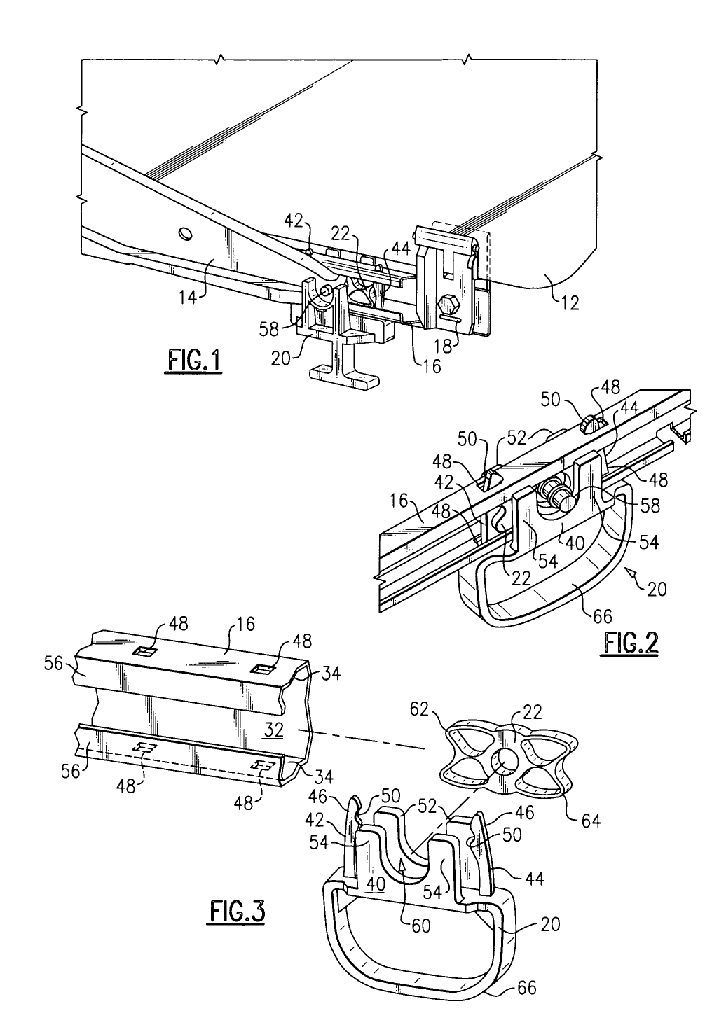

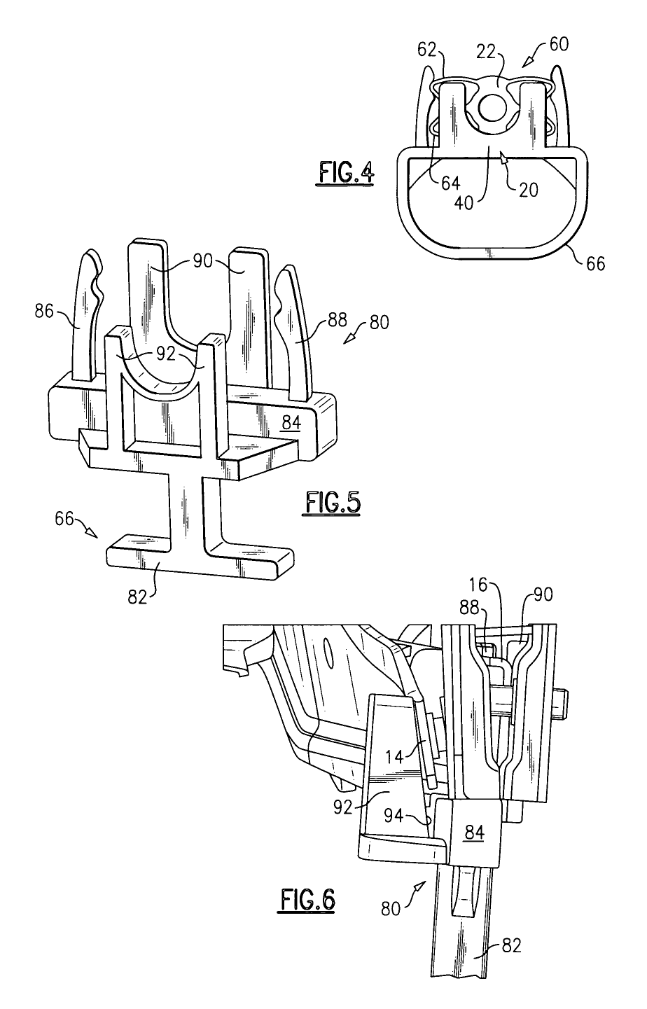

The first 42 and second 44 connector arms, and the first 52 and second 54 pairs of side arms, cooperate to form a box-shaped cavity 60, as shown in FIG. 3. The glider 22 is substantially held within this cavity 60 (see FIG. 4) when the glider retainer block 20 is attached to the window lift channel 16 (see FIG. 2). As shown in FIG. 3, the glider 22 includes first 62 and second 64 bearing surfaces that directly engage the guide grooves 34 (FIG. 2). The glider 22 is preferably formed from plastic, however, any low-friction material can be used to form the glider 22.

The glider retainer block 20 also includes a grip 66 that extends outwardly from the body portion 40. The grip 66 extends outwardly in a direction opposite from the first 42 and second 44 connector arms, and from the first 52 and second 54 pairs of side arms. In this example, the grip 66 comprises a C-shaped handle. An installer grips the grip 66 to manually attach and detach the glider retainer block 20 from the window lift channel 16.

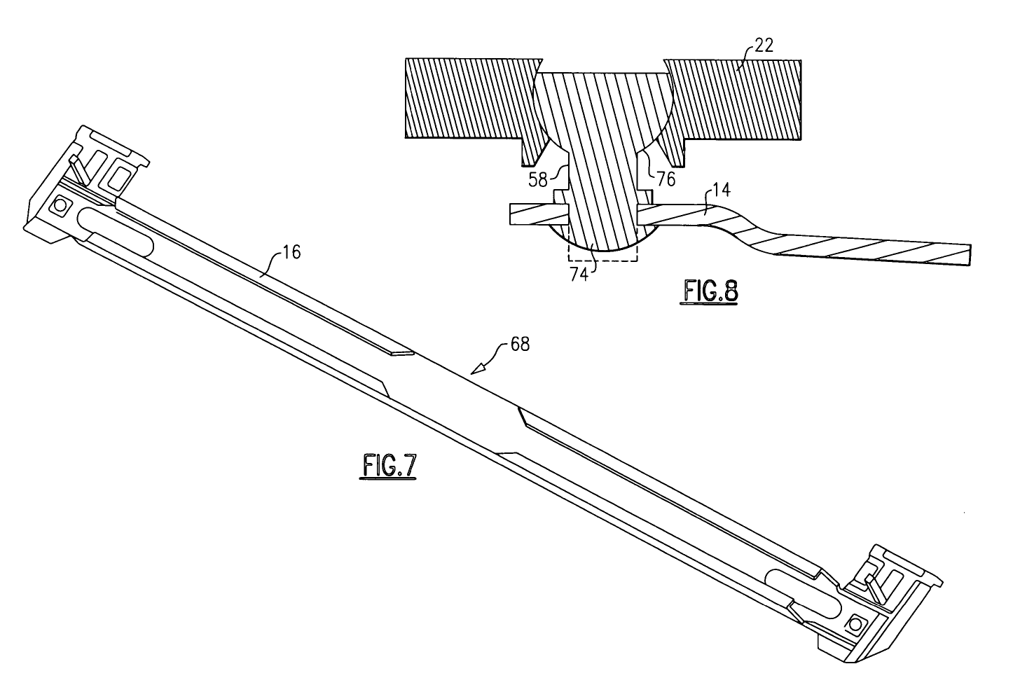

The window lift channel 16 includes a C-shaped portion within an open area formed between the inwardly extending flanges 56. An access slot 68 (FIG. 7) is formed near a center portion of the window lift channel 16. The glider 22 is inserted into the window lift channel 16 through this access slot 68. The glider 22 is assembled in this manner because the window lift channel 16 and the clamps 18 are typically provided as a pre-assembled unit. If the window lift channel 16 and clamps 18 are not pre-assembled as a unit, then the glider 22 could optionally be inserted through an end opening at one of the ends of the window lift channel 16.

As discussed above, the glider retainer block 20 is selectively attached to the window lift channel 16 to hold the glider 22 and regulator arm 14 (FIG. 1) in a desired shipping and installation position. Thus, the window regulator assembly can be installed onto the window lift channel 16 and held in a fixed position during shipping by the glider retainer block 20. Once the assembly reaches a vehicle installation location, the window 12 can be attached to the window lift channel 16 with the clamps 18. Once the window 12 is installed, the glider retainer block 20 is detached and the glider 22 is free to move.

FIGS. 5 and 6 show another example of a glider retainer block 80. The glider retainer block 80 is similar to that of FIGS. 2-4 but instead of having C-shaped handle for the grip 66 the glider retainer block 80 has a T-shaped handle 82.

Further, the glider retainer block 80 has a body portion 84 with first 86 and second 88 connector arms that are similar to those of the glider retainer block 20 of FIGS. 2-4. The glider retainer block 80 also has first 90 and second 92 pairs of side arms that are similar to those of glider retainer block 20 of FIGS. 2-4.

An angled surface 94 (FIG. 6) is formed on an inner arm surface of each of the second pair of arms 92. The angled surface 94 tips or tilts the window lift channel 16 into an open position for better glass insertion. Due to the pivotal connection portion 76 of the fastener 58, the window lift channel 16 can tip relative to the regulator arm 14 at various angles. To reduce this variably, the angled surface 94 abuts against the regulator arm 14, which allows the window lift channel 16 and regulator arm 14 to be held at a consistent angle relative to each other to further facilitate insertion of the window 12 into the clamps 18. The benefit of this configuration is that the glider retainer block 80 can provide repeatable and consistent fore/aft location of the glider 22 using the first 86 and second 88 connector arms, and can provide a repeatable and consistent angled interface between the window lift channel 16 and regulator arm 14.

In each embodiment, the glider retainer block provides a simple and effective way to hold the window regulator assembly in a proper and consistent installation position, which accordingly allows the clamps to be consistently clamped to the same location on each window.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A glider retainer block for a window regulator comprising:
a glider supported by a window lift channel; and
a retainer block selectively attached to said window lift channel to hold said glider in a desired installation position prior to attaching a window to the window lift channel.

2. The glider retainer block according to claim 1 wherein said glider includes structure adapted for attachment to at least one regulator arm.

3. The glider retainer block according to claim 1 wherein said glider includes a first engagement surface and a second engagement surface facing opposite of said first engagement surface, and wherein said first and said second engagement surfaces comprise bearing surfaces that directly contact said window lift channel.

4. The glider retainer block according to claim 1 wherein said retainer block includes at least one connector portion that selectively fixes said retainer block to said window lift channel such that said glider is prevented from moving relative to said window lift channel.

5. The glider retainer block according to claim 4 wherein said at least one connector portion comprises a resilient gripping member.

6. The glider retainer block according to claim 1 wherein said retainer block includes first and second pairs of side arms with an angled surface being formed on an inwardly facing surface of one of the first and second pairs of side arms and wherein said angled surface is formed to abut against a regulator arm.

7. A window regulator assembly comprising:
a window lift channel;
at least one clamp mounted to said window lift channel, said at least one clamp configured to receive a window;
a glider received within said window lift channel, said glider being attached to a regulator arm; and
a retainer block selectively attached to said window lift channel to hold said glider in a desired installation position prior to clamping the window to said window lift channel with said at least one clamp.

8. The window regulator assembly according to claim 7 wherein said retainer block includes a body portion, at least one connector extending outwardly from said body portion to selectively grip said window lift channel, and at least one arm extending outwardly from said body portion to engage a side surface of window lift channel.

9. The window regulator assembly according to claim 8 wherein said retainer block includes a grip extending outwardly from said body portion, said grip being selectively actuated to move said retainer block between attached and detached positions.

10. The window regulator assembly according to claim 7 wherein said retainer block includes an angled surface that abuts against said regulator arm to lock and hold a desired angle between said regulator arm and said window lift channel.

11. The window regulator assembly according to claim 7 wherein said at least one window lift channel comprises a guide channel that has a side surface and first and second guide grooves facing each other from opposite edges of said side surface, said glider slidably engaging said first and said second guide grooves.

12. The window regulator assembly according to claim 11 wherein each of said first and said second guide grooves includes at least one aperture that receives a connecting portion of said retainer block.

13. The window regulator assembly according to claim 7 wherein said glider is freely movable relative to said window lift channel along a glide path when said retainer block is detached from said window lift channel.

14. A method of assembling a window regulator and window comprising the steps of:
(a) installing a glider into a window lift channel;
(b) coupling a regulator arm to the glider; and
(c) attaching a retainer block to the window lift channel to hold the glider in a desired installation position prior to securing a window to the window lift channel.

15. The method according to claim 14 including the step of (d) clamping the window to the window lift channel subsequent to step (c).

16. The method according to claim 15 including the step of (e) detaching the retainer block from the window lift channel subsequent to step (d).

17. The method according to claim 16 includes positioning the regulator arm and window lift channel in a desired angled relationship to each other by abutting the regulator arm against an inner facing angled surface of the retainer block.
